(19) United States
(12) Patent Application Publication
(10) Pub. No.: US 2013/0069482 A1
(43) Pub. Date: Mar. 21, 2013

(54) DECOUPLING OF ELECTRIC POWER FROM PIEZOELECTRIC TRANSDUCERS WITH THE OPPORTUNITY TO REPOLARIZE SAID TRANSDUCERS

(71) Applicant: Andreas Wolff, Munchen (DE)

(72) Inventor: Andreas Wolff, Munchen (DE)

(21) Appl. No.: 13/699,146

(22) PCT Filed: May 13, 2011
(86) PCT No.: PCT/EP11/57767

§ 371 Date: Nov. 20, 2012

(30) Foreign Application Priority Data
May 20, 2010 (DE) 10 2010 021 094.3

(51) Int. Cl. H02N 2/18

(52) U.S. Cl. 310/319

(57) ABSTRACT

An apparatus produces electric power from mechanical vibrations at a frequency f. The apparatus provides a piezo element, which is moved by the mechanical vibration, for producing an electric AC voltage, and also an impedance matching device for matching the impedance of the piezo element to an optional rectifier. The apparatus has an electrically connected capacitive energy store and an energy user, which is connected in electrical parallel with the energy store and to which an output voltage is applied. The piezo element has an inductive element electrically connected to it such that an electric parallel resonant circuit is formed by the inductive element and a capacitance. The electric parallel resonant circuit effectively increases an electric output power for the apparatus.

### CROSS REFERENCE TO RELATED APPLICATIONS

This application is based on and hereby claims priority to International Application No. PCT/EP2011/057767 filed on May 13, 2011 and German Application No. 10 2010 021 094.3 filed on May 20, 2010, the contents of which are hereby incorporated by reference.

### BACKGROUND

The present invention relates to a device and to uses of the device.

In particular piezoelements in the form of, for instance, a multilayer assembly are used as energy transducers for what is termed energy harvesting (EH) for providing electric energy from mechanical energy. Piezoelectric energy transducers can over time become depolarized or, as the case may be, partially depolarized under the influence of external factors such as, for example, pressure and temperature. That applies especially to piezoelements made of what are termed soft piezoelectric materials having a low coercive pressure. Said depolarizing or, as the case may be, partial depolarizing leads to a poorer electric power output from the energy-transducing process. Hard piezoelectric materials exhibit partial depolarizing of such kind to only a small extent owing to high coercive pressures. As a rule, though, hard materials of such type have an electric power output that is lower than that of soft piezoelectric materials.

The convention is to use piezoelectric energy transducers in the case of which an electric interconnection arrangement includes a rectifier circuit with downstream impedance matching to an energy store and an energy load. No repolarizing of the piezoelement takes place, for example, in the case of a conventional arrangement. One approach would be to repolarize the energy accumulated in the energy store by a separate repolarizing circuit at specific intervals. That, though, would have the disadvantage of requiring a part of the stored energy, with a consequent reduction in transducing efficiency. However, a repolarizing circuit of such kind also imposes circuitry demands. The convention is to use energy transducers in the case of which an electric circuit includes a rectifier circuit with downstream impedance matching to an energy store and an energy load. The impedance is matched by, for example, what are termed boost converters, step-down converters, or charge pumps.

### SUMMARY

One potential object is to increase an electric power output in the case of a piezoelement for producing electric energy from in particular narrowband, mechanical vibrations. It should in particular be possible to use a capacitive energy component stored in the piezoelement, and an electric output voltage under load and an electric power output are to be increased. It should be possible for a mechanical resonant frequency of the piezoelectric energy transducer to be electrically matched to a frequency of the mechanical vibrations. The aim is to effectively improve electric decoupling particularly in the case of energy produced from mechanical vibrations having a frequency f.

According to a first aspect, a device for producing electric energy from mechanical vibrations having a frequency f is provided, with the device being fitted with: A piezoelement, moved by the mechanical vibrations, for producing an electric a.c. voltage, an impedance-matching unit for matching the impedance of the piezoelement to an optional rectifier, an electrically connected capacitive energy store C_{S}, and an energy load R that is connected electrically in parallel with energy store C_{S} and to which an output voltage U is applied. The device is characterized in that an inductive element L is electrically connected to the piezoelement in such a way that an electric parallel resonant circuit will be formed by the inductive element L and a capacitor C. According to a second aspect, the proposed device is used for producing electric energy from mechanical vibrations for providing an electric voltage and an electric power output.

An electric power output will be simply and effectively increased by directly connecting a piezoelement to at least one inductive element L.

According to another advantageous embodiment, inductive element L can be electrically connected between the two poles of output voltage U electrically in series with the piezoelement and capacitive element C can be electrically connected electrically in parallel with inductive element L. A piezoelement having an electric connection according to that embodiment simultaneously uses the electric energy obtained from the mechanical energy for repolarizing the piezoelectric element in the case of energy production from narrowband mechanical vibrations having a frequency f. Directly connecting a piezoelement to an inductive element L and a capacitive element C enables the electric power output to be increased. An electric output voltage will therein be multiplied by an electric resonance. Output voltage U increased by a resonance can directly repolarize the piezoelement via inductive element L. The energy required therefor will be very low owing to permanent repolarizing of that kind, which will directly enhance the efficiency of the energy-transducing process. The necessary electric connection arrangements will require little effort. The effect of such arrangements will be long-term operational stability with a highly efficient energy transducer.

According to another advantageous embodiment, inductive element L can be connected electrically in parallel with the piezoelement and capacitive element C can be provided as a capacitive part Cₑₗ of the piezoelement. Inductive element L is therein rated appropriately. It is dimensioned such as to compensate a capacitive part Cₑₗ of the piezoelement as well as possible. Cₑₗ and L therein form a high-resistance parallel resonant circuit at resonant frequency f.

According to another advantageous embodiment, inductive element L can be electrically connected electrically in parallel with the piezoelement and another capacitive element C_{w} can be electrically connected electrically in parallel with inductive element L. Capacitive element C can in that way be produced from capacitive part Cₑₗ of the piezoelement and another capacitor C_{w} connected electrically in parallel with inductive element L and the piezoelement. Connecting a capacitive element C of such kind in parallel with inductive element L will enable a rating of the necessary inductance to be effectively reduced with the resonant frequency remaining the same.

According to the above three advantageous embodiments, a capacitive and otherwise unused electric energy component stored in a piezoelement can be decoupled from an energy-transducing process. Piezoelectric materials having a low coupling factor can in that way be used particularly advantageously for the production of energy by piezoelements. Another advantage is that an electric resonance will enable an electric output voltage effective under a load to be increased by 50 to 100% depending on the coupling factor. That will result likewise in efficiency increases of between 100 and 300%. A mechanical resonant frequency of a piezoelectric energy transducer can moreover by dimensioning inductive element L be matched to the predefined frequency f of the mechanical vibration

F(t)=Fₘₐₓ·sin(2π·f·t). (1)

That is especially advantageous because matching of said kind can only be performed mechanically. Mechanical matching operations are more complex and virtually impossible to perform retrospectively. It is, for example, possible to vary the resonant frequency by a simple changeover of different capacitances and inductances with no changes to an energy-transducer module's mechanical properties.

According to another advantageous embodiment, a diode can be connected electrically in parallel with the piezoelement and in the reverse direction in terms of the piezoelement's voltage. Rectifying by a diode connected in parallel with the piezoelement results in the following advantages: Electric voltages having a counter-polarity orientation and possibly leading to additional depolarizing of a piezoelement can be avoided and a doubling in voltage can be achieved compared with when conventional bridge rectifying is employed. Further provided is impedance doubling, which can be advantageous if impedance transforming can in that way be avoided. Voltage losses due to a diode forward voltage are furthermore halved compared with when a bridge circuit is employed. Fewer components will moreover be needed compared with when conventional bridge rectifying is employed, bringing cost benefits as well as advantages in terms of installation space requirements.

According to another advantageous embodiment, instead of or in addition to a diode it is possible for an active rectifier to be electrically connected as a controllable electronic switch that opens or closes synchronously with a zero crossing during a change in polarity caused by a driving circuit.

According to another advantageous embodiment, a bridge rectifier circuit can be connected electrically in parallel with the piezoelement or electrically in parallel with capacitive energy store C_{S}.

According to another advantageous embodiment, the capacitance of capacitive energy store C_{S} can be at least 10 times that of capacitive element C.

According to another advantageous embodiment, a material of the piezoelement can be a soft piezoelectric material or hard lead zirconate titanate, or the material can have a small coupling factor.

According to another advantageous embodiment, capacitive energy store C_{S} can be a double-layer capacitor.

According to another advantageous embodiment, an impedance-matching unit can be a boost converter, a step-down converter, or a charge pump.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a first exemplary embodiment of the proposed device;

FIG. 2 shows a second exemplary embodiment of the proposed device.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

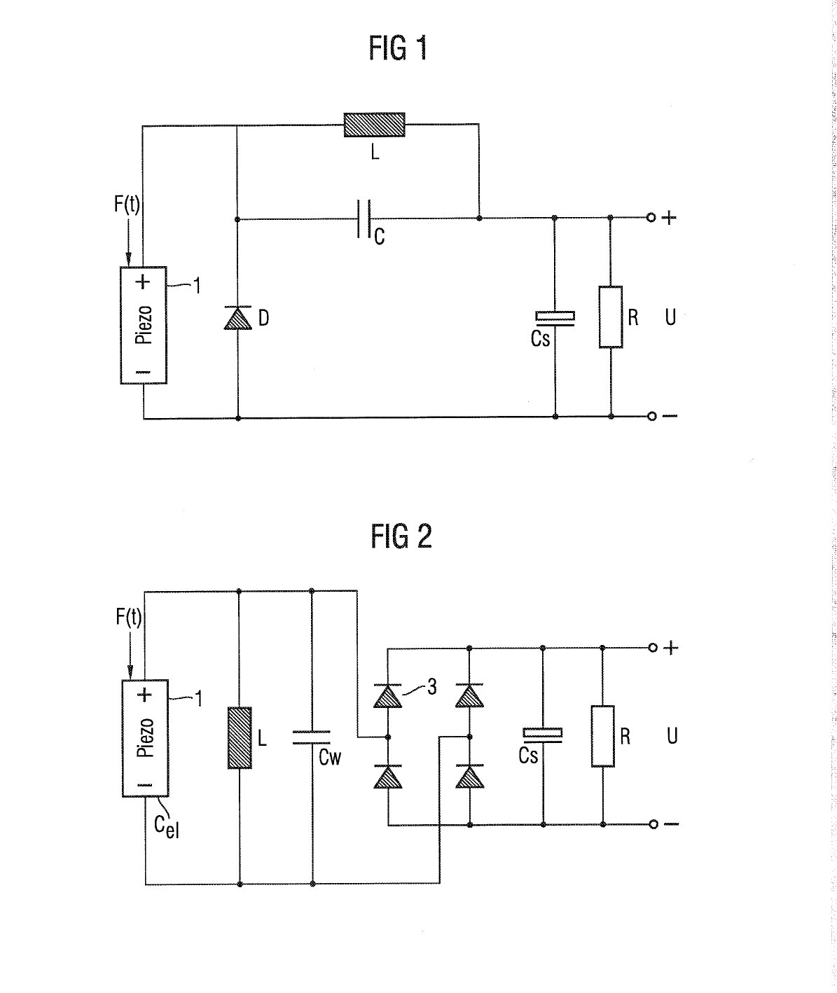

FIG. 1 shows a first exemplary embodiment of the proposed device. FIG. 1 shows a device for producing electric energy from mechanical vibrations having a frequency f, with a time-dependent force F(t) acting upon a piezoelement 1. Piezoelement 1 produces an electric a.c. voltage as a result of the mechanical vibrations due to movement. The piezoelement supplies an electric energy load R with an output voltage U or, as the case may be, an associated power output. An energy store C_{S} is electrically connected between piezoelement 1 and energy load R electrically in parallel with energy load R. An inductive element L is electrically connected to piezoelement 1. Inductive element L is connected between the two poles of output voltage U electrically in series with piezoelement 1, with a capacitive element C being electrically connected electrically in parallel with inductive element L. Directly connecting piezoelement 1 to an inductive element L and a capacitive element C enables an electric power output to be increased. Output voltage U is multiplied by a resonance. Said output voltage U is rectified in such a way that no electric voltages oriented counter to the polarity are applied to piezoelement 1 and voltage U arising on capacitor C_{S} will repolarize piezoelement 1 or, as the case may be, maintain the polarity via inductive element L acting as a power choke. For proper functioning it is advantageous for a capacitance C_{S} to be large relative to capacitance C. Another connection arrangement comprising impedance transforming, energy storage, and an energy load remains substantially unchanged as compared with the related art. The following formulas 2 show the physical correlations:

$${C}_{el} = {( n \cdot {d}_{33} )}^{2} \cdot k \cdot [ \frac{1}{{k}_{rms}^{2}} - 1 ] , \\ where k = \frac{Y \cdot A}{1}$$

$$and {k}_{rms} = \sqrt{\frac{{f}_{p}^{2} - {f}_{s}^{2}}{{f}_{p}^{2}}}$$

$$L = \frac{1}{{( 2 \cdot π \cdot f )}^{2} \cdot {C}_{el}}$$

The following evaluations can be made by way of example in connection with this first exemplary embodiment. A typical multilayer stack can for that purpose have the following data:

Coupling factor kᵣₘₛ=0.7

Number of layers n=350

Piezoelectric coefficient d₃₃=950 pm/V

Spring stiffness of the piezoelement k=40 N/μm.

The electric components employed are rated as follows:

Capacitor c=25 μF

Power choke L=27 mH with R_{S}, which is the series resistance of the winding,

Storage capacitor C_{S}=1 mF and far higher than C,

Rectifier diode D, with the diode's cathode having to be connected on a + side of the piezoelement. Modeling calculations produce the following values for the embodiment:

At a vibration frequency of f=166 Hz with a force amplitude of Fₚ=200 N, the maximum polarizing voltage Uₚ in the case of resonance will be 100 V at the piezo transducer when R_{S}=1 Ω. The result will be polarizing voltages Uₚ of accordingly 200 V and 340 V for lower ohmic losses R_{S} of the power choke of 0.5 and 0.3 Ω.

For Fₚ=100 N, the result will be as follows in the case of resonance:

When R_{S}=1 Ω, the maximum polarizing voltage will be 50 V at the piezo transducer;

when R_{S}=0.5 Ω, the maximum polarizing voltage will be 100 V at the piezo transducer;

when R_{S}=0.3 Ω, the maximum polarizing voltage will be 170 V at the piezo transducer.

The values given in this example were determined using a linear model. Deviations from the optimal component values may occur owing to the piezoelement's non-linear actual behavior. The simplest way to ascertain said optimal values is to experimentally vary the component values.

The voltages produced using the connection arrangement according to FIG. 1 are sufficient in the case of multilayer stacks with individual layers around 100 μm thick to generate field strengths that are above soft piezoelectric materials' coercive field strengths. A repolarizing process will be induced thereby that stabilizes the polarity status necessary for a good level of efficiency on the part of the transducer.

Instead of a diode D, for synchronous rectifying it is possible to use what is termed an active rectifier that is a controllable electronic switch, for example a MOSFET that opens or, as the case may be, closes synchronously with a zero crossing during a change in polarity caused by a driving circuit. What is advantageous is a low voltage drop of a few tens of mV in the through-connected condition, as a result of which the circuit's energy efficiency will be further enhanced. That is countered by the disadvantage that a necessary driving circuit consumes part of the stored energy. Whether the advantages predominate will depend on the prevailing current or, as the case may be, voltage ranges during rectifying. The circuit furthermore first needs to have energy available in order to carry out rectifying. That requirement can be met by leaving diode D in the circuit so that capacitor C_{S} will be charged until synchronous rectifying takes place. According to a device as shown in FIG. 1, piezoelement 1 can be repolarized.

FIG. 2 shows a second exemplary embodiment of the proposed device. The device produces electric energy from mechanical vibrations F(t) having a frequency f. The device has a piezoelement 1, moved by the mechanical vibrations, for producing an electric a.c. voltage. Piezoelement 1 makes electric power available for an energy load connected electrically in parallel. An energy store C_{S} is connected electrically in parallel on energy load R. Said energy store C_{S} is a capacitive energy store. FIG. 2 shows a bridge rectifier circuit 3 between piezoelement 1 and capacitive energy store C_{S}. According to an embodiment, only an inductive element is connected electrically in parallel with piezoelement 1. An electric power output will be increased by directly connecting piezoelement 1 to said inductive element L in that way. An inductive element L with an appropriate rating is therein connected in parallel with piezoelement 1. Said inductive element is dimensioned such as to compensate capacitive part Cₑₗ of piezoelement 1 as well as possible. Cₑₗ and L therein form a high-resistance parallel resonant circuit at resonant frequency f. The further connection arrangement comprising rectifying, impedance matching, and energy storage for the energy load remains substantially unchanged as compared with the related art. According to an exemplary embodiment, piezoelement 1 can as a typical multilayer stack have the following data:

Coupling factor kᵣₘₛ=0.7

Number of layers n=350

Piezoelectric coefficient d₃₃=950 pm/V

Spring stiffness of the piezoelement k=40 N/μm.

Based on this data of piezoelement 1, a value of 4.5 μF is obtained for a capacitive part Cₑₗ of the piezoelement. For a resonant frequency of, for example, f=175 Hz it would be necessary to employ an inductive element rated at 184 mH for the piezoelement's connection. A power choke of said inductive element would be cumbersome and expensive according to the related art.

FIG. 2 shows an exemplary embodiment in the case of which an additional capacitive element C is electrically connected alongside inductive element L. Connecting a capacitor C having a rating of, for example, C=25 μF in parallel with the power choke in that way will enable the magnitude of said power choke's requisite inductance to be effectively reduced with the resonant frequency unchanged. The inductance will then be only L=27 mH. That value is easy to realize. In designing power choke L it must be borne in mind that, depending on the excitation of piezoelement 1 and attenuating of the oscillating circuit by power load R, high currents can flow through inductive element L that result in ohmic losses through the coil wire and possibly in saturating of the magnetic core of power choke L and hence in further undesired electric losses. Said losses would excessively attenuate the oscillating circuit's electric resonance and reduce the energy gain. The losses in the piezoelectric material may likewise cause the oscillating circuit to be attenuated. The use of lower-loss piezoelectric materials, for example hard PZT, can be advantageous here.

Another advantage according to the exemplary embodiment shown in FIG. 2 is that when less energy is consumed by a power load R, for example in standby mode, energy store C_{S} will keep being charged until the circuit's losses, depending on the quality of the oscillating circuit, are as great as the energy supplied by the piezoelement. The achievable output voltage can then be a multiple of the standard output voltage. That is important especially when what are termed supercaps or double-layer capacitors are used as energy stores because their charging voltage increases with increasing charging energy and the charging current would come to a standstill. With the aforementioned data and an ohmic resistance—the 27-mH power choke—of 750 mΩ, modeling calculations indicate a 60% increase in output voltage U after rectification and a 147% increase in the electric power output at a power-matched resistor R rated at 300 Ω. Even greater increases are possible in the case of piezoelectric materials having a low coupling factor kᵣₘₛ.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-14. (canceled)

15. A device for producing electric energy from mechanical vibrations having a frequency f, comprising:
a piezoelement, moved by the mechanical vibrations, to produce an electric a.c. voltage;
an electrically connected capacitive energy store;
an energy load connected electrically in parallel with the energy store and to which an output voltage is applied;
a capacitive element; and
an inductive element electrically connected to the piezoelement in such a way that an electric parallel resonant circuit is formed by the inductive element and the capacitive element.

16. The device as claimed in claim 15, further comprising:
a rectifier; and
an impedance-matching unit to match impedance of the piezoelement to the rectifier.

17. The device as claimed in claim 15, further comprising:
a rectifier impedance matched to the piezoelement.

18. The device as claimed in claim 15, wherein
the inductive element is electrically connected between two poles of the output voltage, electrically in series with the piezoelement, and
the capacitive element is connected electrically in parallel with the inductive element.

19. The device as claimed in claim 15, wherein
the inductive element is connected electrically in parallel with the piezoelement, and
the capacitive element is provided as a capacitive part of the piezoelement.

20. The device as claimed in claim 19, wherein
the capacitive element is produced from the capacitive part of the piezoelement, and
the device further comprises a capacitor connected electrically in parallel with the inductive element.

21. The device as claimed in claim 18, wherein
a diode is connected electrically in parallel with the piezoelement and in a reverse direction in terms of the a.c. voltage produced by the piezoelement.

22. The device as claimed in claim 21, wherein
in addition to the diode, an active rectifier is electrically connected as a controllable electronic switch that opens or closes synchronously with a zero crossing during a change in polarity caused by a driving circuit.

23. The device as claimed in claim 18, wherein
an active rectifier is electrically connected as a controllable electronic switch that opens or closes synchronously with a zero crossing during a change in polarity caused by a driving circuit, the active rectifier being impedance matched to the piezoelement.

24. The device as claimed in claim 15, wherein
a bridge rectifier circuit is connected electrically in parallel with the piezoelement and electrically in parallel with the capacitive energy store.

25. The device as claimed in claim 18, wherein
the capacitive energy store has a capacitance at least ten times that of the capacitive element.

26. The device as claimed in claim 15, wherein
the piezoelement is formed from a material selected from the group consisting of a soft piezoelectric material, hard lead zirconate titanate, and a material having a small coupling factor.

27. The device as claimed in claim 15, wherein
the capacitive energy store is a double-layer capacitor.

28. The device as claimed in claim 15, further comprising:
a rectifier; and
an impedance-matching device to match impedance of the piezoelement to the rectifier, the impedance-matching device being selected from the group consisting of a boost converter, a step-down converter, and a charge pump.

29. A method comprising:
producing mechanical vibrations having a frequency f;
producing electric energy from the mechanical vibrations, the electric energy being produced from a device comprising:
a piezoelement, moved by the mechanical vibrations, to produce an electric a.c. voltage;
an electrically connected capacitive energy store;
a capacitive element; and
an inductive element electrically connected to the piezoelement in such a way that an electric parallel resonant circuit is formed by the inductive element and the capacitive element; and
providing an electric power output and an output voltage for an energy load connected electrically in parallel with the energy store.

30. The method as claimed in claim 29, wherein the device further comprises:
a rectifier circuit; and
an impedance matching unit to impedance match the rectifier circuit and the piezoelement.

31. The method as claimed in claim 30, wherein
the rectifier circuit comprises a diode connected electrically in parallel with the piezoelement and in a reverse direction in terms of the a.c. voltage produced by the piezoelement.

32. The method as claimed in claim 31, wherein
in addition to the diode, an active rectifier is electrically connected as a controllable electronic switch that opens or closes synchronously with a zero crossing during a change in polarity caused by a driving circuit.

33. The method as claimed in claim 30, wherein
the rectifier circuit comprises an active rectifier electrically connected as a controllable electronic switch that opens or closes synchronously with a zero crossing during a change in polarity caused by a driving circuit.

34. The method as claimed in claim 30, wherein
the rectifier circuit comprises a bridge rectifier circuit connected electrically in parallel with the piezoelement and electrically in parallel with the capacitive energy store.

35. The method as claimed in claim 29, wherein the device does not have a rectifier circuit.
